(19) United States
(12) Patent Application Publication
(10) Pub. No.: US 2024/0396050 A1
(43) Pub. Date: Nov. 28, 2024

(54) POWER STORAGE CELL

(71) Applicant: TOYOTA JIDOSHA KABUSHIKI KAISHA, Toyota-shi (JP)

(72) Inventors: Takeshi ABE, Okazaki-shi (JP); Tomoyuki UEZONO, Okazaki-shi (JP); Ryuta SUGIURA, Toyota-shi (JP); Takenori IKEDA, Owariasahi-shi (JP); Yuki TAKAHAshi, Miyoshi-shi (JP); Kenta KIMURA, Toyota-shi (JP)

(73) Assignee: TOYOTA JIDOSHA KABUSHIKI KAISHA, Toyota-shi (JP)

(21) Appl. No.: 18/638,106

(22) Filed: Apr. 17, 2024

(30) Foreign Application Priority Data
May 22, 2023 (JP) 2023-083964

(51) Int. Cl. H01M 4/70; H01M 50/107

(52) U.S. Cl. CPC H01M 4/70; H01M 50/107

(57) ABSTRACT

A power storage cell includes an electrode assembly constructed as a wound body in which a positive electrode sheet and a negative electrode sheet are wound with a separator interposed therebetween, a current collector plate, a cell case, and an electrolyte solution. Each of the positive electrode sheet and the negative electrode sheet includes a current collector foil, and an active material layer. The current collector foil includes a main region where the active material layer is provided, and an end region where the active material layer is not provided. A plurality of tabs in the end region are arranged so that a cover region and an exposure region are formed, the cover region covering part of a layer end portion, the exposure region causing the remainder of the layer end portion to be exposed. The current collector plate is connected to the cover region.

### CROSS REFERENCE TO RELATED APPLICATIONS

This nonprovisional application is based on Japanese Patent Application No. 2023-083964 filed on May 22, 2023 with the Japan Patent Office, the entire contents of which are hereby incorporated by reference.

### BACKGROUND

### Field

The present disclosure relates to power storage cells.

### Description of the Background Art

Japanese Patent Laying-Open No. H10-162854 discloses a cylindrical battery that includes an electrode group constructed as a wound body in which a belt-shaped positive electrode plate and a belt-shaped negative electrode plate are wound in a spiral with a separator interposed therebetween, a disk-shaped current collector, a battery case, and an electrolyte solution. The positive electrode plate and the negative electrode plate each have a conductive end that projects outward from an end portion in a longitudinal direction, and the conductive end is connected to the current collector.

### SUMMARY

In a so-called tables power storage cell, which is described in Japanese Patent Laying-Open No. H10-162854 for example, reliable connection is required between a tab of a current collector foil and a current collector plate. Particularly during high-rate charging and discharging for example, the electrolyte solution flows out from an electrode assembly and the electrolyte solution in the electrode assembly may become lacking accordingly.

An object of the present disclosure is to provide a power storage cell that can inhibit lack of an electrolyte solution in an electrode assembly while connection between a current collector foil and a current collector plate can be secured.

A power storage cell according to an aspect of the present disclosure includes: an electrode assembly that includes a positive electrode sheet, a negative electrode sheet, and a separator, and is constructed as a wound body in which the positive electrode sheet and the negative electrode sheet are wound with the separator interposed therebetween; a current collector plate connected to the electrode assembly; a cell case that houses the electrode assembly and the current collector plate; and an electrolyte solution housed in the cell case. Each of the positive electrode sheet and the negative electrode sheet includes a current collector foil, and an active material layer provided on a surface of the current collector foil, the current collector foil includes a main region where the active material layer is provided, the main region being arranged so as to overlap each other in a radial direction of the electrode assembly, and an end region where the active material layer is not provided, the end region lying outside the main region in an axial direction of the electrode assembly, the active material layer includes a layer end portion formed by an end portion in the axial direction, the end region includes a plurality of tabs that are separate from each other in a circumferential direction of the electrode assembly and are folded toward the main region, the plurality of tabs are arranged so that a cover region and an exposure region are formed, the cover region covering part of the layer end portion, the exposure region causing a remainder of the layer end portion to be exposed, and the current collector plate is connected to the cover region.

The foregoing and other objects, features, aspects, and advantages of the present disclosure will become apparent from the following detailed description on the present disclosure, which will be understood with reference to the accompanying drawings.

### BRIEF DESCRIPTION OF THE DRAWINGS

FIG. 1 is a cross-sectional view that schematically illustrates a power storage cell according to an embodiment of the present disclosure.

FIG. 2 is a plan view that schematically illustrates an electrode assembly.

FIG. 3 is a front view that schematically illustrates a positive electrode sheet before it is wound.

FIG. 4 is a plan view that schematically illustrates a variation of the electrode assembly.

FIG. 5 is a plan view that schematically illustrates a variation of the electrode assembly.

FIG. 6 is a plan view that schematically illustrates a variation of the electrode assembly.

FIG. 7 is a plan view that schematically illustrates a variation of the electrode assembly.

### DESCRIPTION OF THE PREFERRED EMBODIMENTS

Embodiments of the present disclosure are described with reference to the drawings. In the drawings referred to below, the same reference numerals are given to identical or equivalent members.

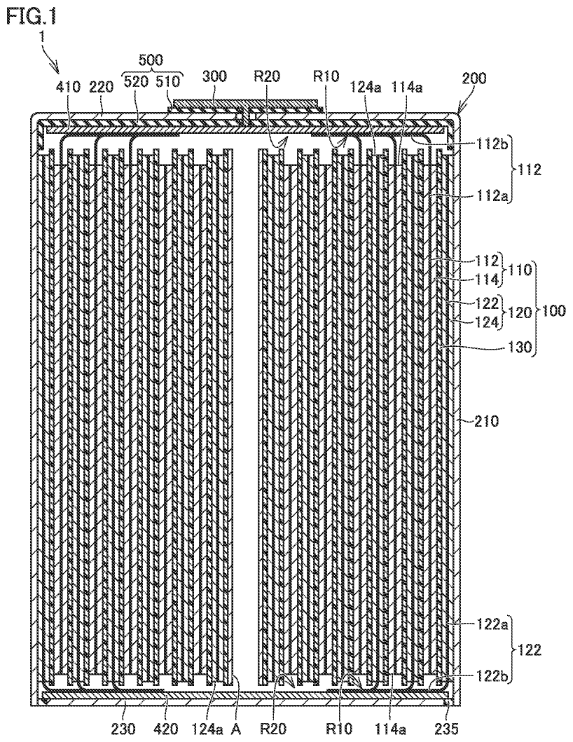

FIG. 1 is a partial cross-sectional view that schematically illustrates a power storage cell 1 according to an embodiment of the present disclosure. Power storage cell 1 is preferably mounted on a vehicle.

As illustrated in FIG. 1, power storage cell 1 includes an electrode assembly 100, a cell case 200, an external terminal 300, a positive electrode current collector plate 410, a negative electrode current collector plate 420, an insulation member 500, and an electrolyte solution (not illustrated).

Electrode assembly 100 includes a positive electrode sheet 110, a negative electrode sheet 120, and a separator 130. Electrode assembly 100 is constructed as a wound body in which positive electrode sheet 110 and negative electrode sheet 120 are wound around a winding core A with separator 130 interposed therebetween.

FIG. 3 is a front view that schematically illustrates positive electrode sheet 110 before it is wound. As illustrated in FIGS. 1 and 3, positive electrode sheet 110 includes a positive electrode current collector foil 112 and a positive electrode active material layer 114. In FIG. 3, the dot pattern denotes positive electrode active material layer 114.

Positive electrode current collector foil 112 is made of metal such as aluminum. Positive electrode current collector foil 112 includes a main region 112a and an end region 112b.

Main region 112a is a region of positive electrode current collector foil 112, where positive electrode active material layer 114 is provided. As illustrated in FIG. 1, main region 112a is arranged so as to overlap each other in a radial direction of electrode assembly 100 (the lateral direction in FIG. 1).

End region 112b is a region of positive electrode current collector foil 112, where positive electrode active material layer 114 is not provided. As illustrated in FIG. 1, end region 112b lies outside main region 112a (i.e., lies on the upper side in FIG. 1) in an axial direction of electrode assembly 100 (the longitudinal direction in FIG. 1).

End region 112b includes a plurality of tabs 112b1 (see FIG. 3), which are separate from each other in a circumferential direction of electrode assembly 100. As illustrated in FIG. 1, each tab 112b1 is folded toward main region 112a. Specifically, each tab 112b1 falls down inward in the radial direction. The upper surface of each tab 112b1 forms an approximately flat surface. Positive electrode current collector plate 410 is connected to each tab 112b1 by welding or the like.

Negative electrode sheet 120 includes a negative electrode current collector foil 122, which is made of metal such as copper, and a negative electrode active material layer 124, which is provided on a surface of negative electrode current collector foil 122.

The structure of negative electrode current collector foil 122 is substantially the same as the structure of positive electrode current collector foil 112. Thus, description on negative electrode current collector foil 122 is simplified. That is, negative electrode current collector foil 122 includes a main region 122a, where negative electrode active material layer 124 is provided, and an end region 122b, which lies outside main region 122a (i.e., lies on the lower side in FIG. 1) in the axial direction. End region 122b includes a plurality of tabs separate from each other in the circumferential direction, and each tab falls down inward in the radial direction. Negative electrode current collector plate 420 is connected to each tab by welding or the like.

Separator 130 is arranged between positive electrode sheet 110 and negative electrode sheet 120. More specifically, separator 130 is arranged only between main region 112a of positive electrode sheet 110 and main region 122a of negative electrode sheet 120, which are adjacent to each other in the radial direction. Separator 130 is made from an insulation material and allows ions to pass therethrough.

Cell case 200 houses electrode assembly 100. In cell case 200, the electrolyte solution (not illustrated) is housed. Cell case 200 is hermetically sealed. Cell case 200 is made of metal such as aluminum. Cell case 200 includes a cylindrical portion 210, a top wall 220, and a bottom wall 230.

Cylindrical portion 210 surrounds the outer circumferential surface of electrode assembly 100.

Top wall 220 is connected to an upper end portion of cylindrical portion 210. In a central portion of top wall 220, a through hole is formed, in which external terminal 300 is inserted.

Bottom wall 230 is connected to a lower end portion of cylindrical portion 210. More specifically, bottom wall 230 is connected to a lower end portion of cylindrical portion 210 with an insulation member 235 interposed therebetween. Bottom wall 230 is in contact with negative electrode current collector plate 420.

External terminal 300 is arranged over top wall 220. In the present embodiment, external terminal 300 forms a positive electrode external terminal. Cell case 200 forms a negative electrode external terminal.

Insulation member 500 insulates cell case 200 and external terminal 300 from each other. Insulation member 500 includes an upper insulation portion 510 and a lower insulation portion 520.

Upper insulation portion 510 is arranged on the upper surface of top wall 220. Upper insulation portion 510 is interposed between the upper surface of top wall 220 and external terminal 300.

Lower insulation portion 520 is arranged on the lower surface of top wall 220. Lower insulation portion 520 is interposed between positive electrode current collector plate 410 and cell case 200.

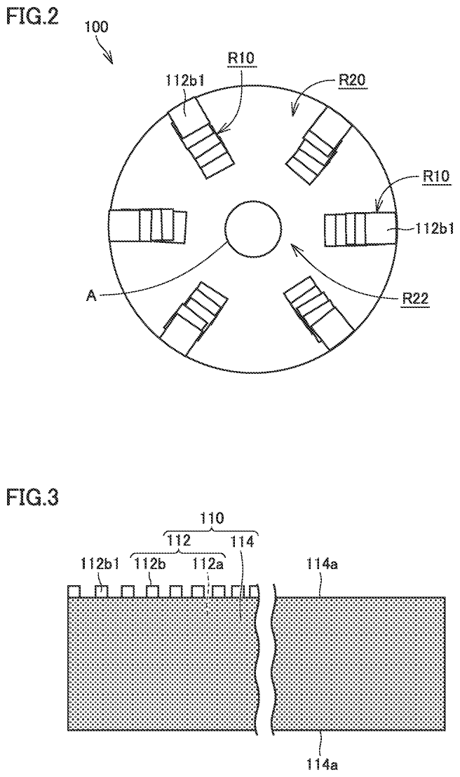

FIG. 2 is a plan view that schematically illustrates electrode assembly 100. Since the lower surface of electrode assembly 100 has a structure that substantially corresponds to that of the upper surface of electrode assembly 100, the structure of the upper surface of electrode assembly 100 is taken as an example in the description below.

As illustrated in FIG. 2, the plurality of tabs 112b1 are arranged so that a cover region R10 and an exposure region R20 are formed. Cover region R10 is a region that partially covers layer end portions 114a and 124a (see FIG. 1) formed by respective end portions of active material layers 114 and 124 in the axial direction. Exposure region R20 is a region that causes the respective remainders of layer end portions 114a and 124a (the region except the region covered by cover region R10) to be exposed.

In the example illustrated in FIG. 2, the plurality of tabs 112b1 are arranged so that the plurality of cover regions (six cover regions) R10 are formed so as to be located at intervals in the circumferential direction of electrode assembly 100. Each cover region R10 extends along the radial direction from an outer end portion of electrode assembly 100 in the radial direction toward an inner end portion of electrode assembly 100 in the radial direction. An end portion of each cover region R10 on the inner side in the radial direction is situated in an intermediate portion between the outer end portion of electrode assembly 100 and the inner end portion of electrode assembly 100 in the radial direction.

Exposure region R20 includes an annular exposure region R22 extending like a ring in the circumferential direction of electrode assembly 100. Annular exposure region R22 lies inside cover region R10 in the radial direction. Exposure region R20 may be different in shape between the upper and lower surfaces of electrode assembly 100. For example, the area of exposure region R20 on the lower surface of electrode assembly 100 may be made larger than the area of exposure region R20 on the upper surface of electrode assembly 100.

As described above, in power storage cell 1 of the present embodiment, connection between each current collector foil 112 and current collector plate 410 and connection between each current collector foil 122 and current collector plate 420 are ensured in respective cover regions R10, and lack of the electrolyte solution in electrode assembly 100 is inhibited since the electrolyte solution that has flowed out from electrode assembly 100 during high-rate charging and discharging, for example, permeates again into electrode assembly 100 through exposure region R20.

Further, when the electrolyte solution is supplied into cell case 200 after electrode assembly 100 is housed in cell case 200 in the manufacture of power storage cell 1, the electrolyte solution effectively permeates into electrode assembly 100 through exposure region R20.

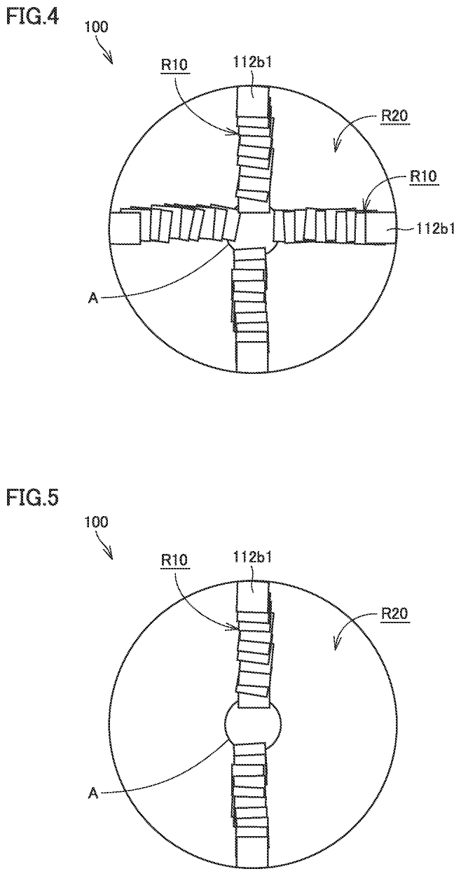

In the above-described embodiment, as illustrated in FIGS. 4 and 5, cover region R10 may be formed into a shape that extends so as to reach the inner end portion of electrode assembly 100 from the outer end portion of electrode assembly 100 in the radial direction. According to this aspect, the degree of freedom is increased in selecting respective connection positions between cover region R10 and current collector plate 410 and between cover region R10 and current collector plate 420.

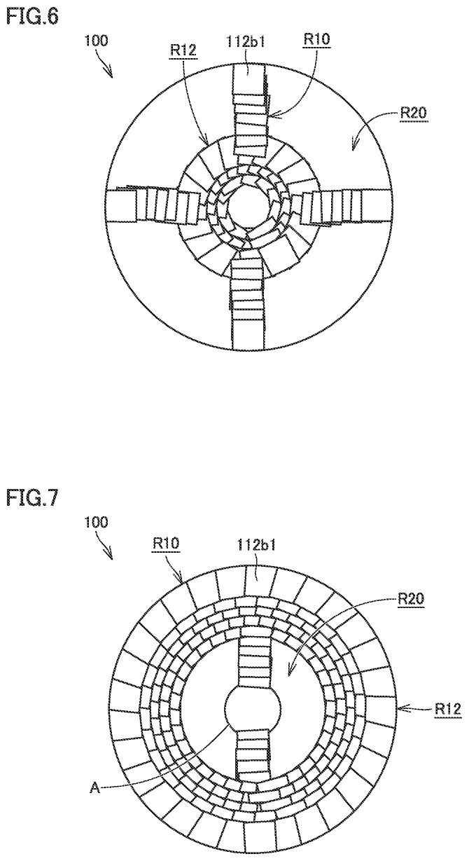

As illustrated in FIGS. 6 and 7, cover region R10 may include an annular cover region R12 extending like a ring in the circumferential direction. In other words, the plurality of tabs 112b1 may be arranged so that annular cover region R12 is formed. According to this aspect, annular cover region R12 effectively interrupts the electrolyte solution flowing out from electrode assembly 100 during high-rate charging and discharging for example, and the electrolyte solution that has flowed out from electrode assembly 100 permeates again into electrode assembly 100 through exposure region R20. As a result, lack of the electrolyte solution in electrode assembly 100 is inhibited with higher reliability.

In the example illustrated in FIG. 6, annular cover region R12 lies inside exposure region R20 in the radial direction. Annular cover region R12 covers winding core A. According to this aspect, a relatively large area is ensured for exposure region R20 and thus, the electrolyte solution smoothly flows into electrode assembly 100 through exposure region R20.

In the example illustrated in FIG. 7, annular cover region R12 lies outside exposure region R20 in the radial direction. According to this aspect, exposure region R20 lies on the winding core A side in electrode assembly 100, where concentration of stress or persistence of heat occurs easily, and thus, the electrolyte solution smoothly flows into electrode assembly 100.

Those skilled in the art will understand that the above-described exemplary embodiments are specific examples of the following aspects.

### [Aspect 1]

A power storage cell comprising:
an electrode assembly that includes a positive electrode sheet, a negative electrode sheet, and a separator, and is constructed as a wound body in which the positive electrode sheet and the negative electrode sheet are wound with the separator interposed therebetween;
a current collector plate connected to the electrode assembly;
a cell case that houses the electrode assembly and the current collector plate; and
an electrolyte solution housed in the cell case, wherein
each of the positive electrode sheet and the negative electrode sheet includes
   a current collector foil, and
   an active material layer provided on a surface of the current collector foil
the current collector foil includes
   a main region where the active material layer is provided, the main region being arranged so as to overlap each other in a radial direction of the electrode assembly, and
   an end region where the active material layer is not provided, the end region lying outside the main region in an axial direction of the electrode assembly,
the active material layer includes a layer end portion formed by an end portion in the axial direction,
the end region includes a plurality of tabs that are separate from each other in a circumferential direction of the electrode assembly and are folded toward the main region,
the plurality of tabs are arranged so that a cover region and an exposure region are formed, the cover region covering part of the layer end portion, the exposure region causing a remainder of the layer end portion to be exposed, and
the current collector plate is connected to the cover region.

In this power storage cell, connection between the current collector foil and the current collector plate is ensured in the cover region, and lack of the electrolyte solution in the electrode assembly is inhibited since the electrolyte solution that has flowed out from the electrode assembly during high-rate charging and discharging, for example, permeates again into the electrode assembly through the exposure region.

### [Aspect 2]

The power storage cell according to aspect 1, wherein the exposure region includes an annular exposure region extending like a ring in the circumferential direction.

### [Aspect 3]

The power storage cell according to aspect 2, wherein the annular exposure region lies inside the cover region in the radial direction.

According to this aspect, permeation of the electrolyte solution from the inner side to the outer side in the radial direction is promoted.

### [Aspect 4]

The power storage cell according to aspect 1, wherein the cover region includes an annular cover region extending like a ring in the circumferential direction.

According to this aspect, the annular cover region effectively interrupts the electrolyte solution flowing out from the electrode assembly during high-rate charging and discharging for example, and the electrolyte solution that has flowed out from the electrode assembly permeates again into the electrode assembly through the exposure region. As a result, lack of the electrolyte solution in the electrode assembly is inhibited with higher reliability.

### [Aspect 5]

The power storage cell according to aspect 4, wherein the annular cover region lies inside the exposure region in the radial direction.

According to this aspect, a relatively large area is ensured for the exposure region and thus, the electrolyte solution smoothly flows into the electrode assembly through the exposure region.

### [Aspect 6]

The power storage cell according to aspect 4, wherein the annular cover region lies outside the exposure region in the radial direction.

According to this aspect, the exposure region lies on the winding core side in the electrode assembly, where concentration of stress or persistence of heat occurs easily, and thus, the electrolyte solution smoothly flows into the electrode assembly.

Although embodiments of the present disclosure have been described, it should be understood that the herein-disclosed embodiments are presented by way of illustration and example in every respect and are not to be taken by way of limitation. The scope of the present disclosure is defined by the claims and intended to include all changes within the purport and scope equivalent to the claims.

What is claimed is:

1. A power storage cell comprising:
an electrode assembly in which a positive electrode sheet and a negative electrode sheet are wound with a separator interposed therebetween;
a current collector plate connected to the electrode assembly;
a cell case that houses the electrode assembly and the current collector plate; and
an electrolyte solution housed in the cell case, wherein
each of the positive electrode sheet and the negative electrode sheet includes
a current collector foil, and
an active material layer provided on a surface of the current collector foil,
the current collector foil includes
a main region where the active material layer is provided, and
an end region where the active material layer is not provided,
the active material layer includes a layer end portion formed by an end portion in an axial direction of the electrode assembly,
the end region includes a plurality of tabs folded toward the main region,
the plurality of tabs are arranged so that a cover region and an exposure region are formed, the cover region covering part of the layer end portion, the exposure region causing a remainder of the layer end portion to be exposed, and
the current collector plate is connected to the cover region.

2. The power storage cell according to claim 1, wherein the exposure region includes an annular exposure region extending like a ring in a circumferential direction of the electrode assembly.

3. The power storage cell according to claim 2, wherein the annular exposure region lies inside the cover region in a radial direction of the electrode assembly.

4. The power storage cell according to claim 1, wherein the cover region includes an annular cover region extending like a ring in a circumferential direction of the electrode assembly.

5. The power storage cell according to claim 4, wherein the annular cover region lies inside the exposure region in a radial direction of the electrode assembly.

6. The power storage cell according to claim 4, wherein the annular cover region lies outside the exposure region in a radial direction of the electrode assembly.
